(19) United States
(12) Patent Application Publication
(10) Pub. No.: US 2026/0172727 A1
(43) Pub. Date: Jun. 18, 2026

(54) SPEAKER GRILLE FOR VEHICLE

(71) Applicant: Honda Motor Co., Ltd., Tokyo (JP)

(72) Inventors: Eric M. Daulton, Marysville, OH (US); Eun Jin LEE, Torrance, CA (US)

(21) Appl. No.: 18/984,721

(22) Filed: Dec. 17, 2024

(51) Int. Cl. H04R 1/02; B60R 11/02

(52) U.S. Cl. CPC H04R 1/023; B60R 11/0217; H04R 1/025; H04R 2400/11; H04R 2499/13

(57) ABSTRACT

A speaker grille for a vehicle is disclosed. The speaker grille comprises a base adapted to enclose a speaker. The base extends along a longitudinal direction and defines a first surface, an opposing second surface, a first side end, an opposing second side end, a top end, and an opposing bottom end. The base comprises a first section defining a plurality of arrays of first through-holes extending along the longitudinal direction, and a second section adjacent to the first section defining a plurality of arrays of second through-holes extending along an oblique direction relative to the longitudinal direction. The speaker grille comprises a plurality of first ribs disposed in the first section and extending along the longitudinal direction, and a plurality of second ribs disposed in the second section and extending along the oblique direction.

### BACKGROUND

The disclosed subject matter relates generally to a vehicle. More particularly, the disclosed subject matter relates to a speaker grille for the vehicle.

Conventionally, speakers that are installed in vehicles are enclosed by a speaker grille. Speaker grilles that are in production are typically injection molded. Designers of such speaker grilles often face challenges in balancing aesthetic appeal of the speaker grille with audio performance. As such, designers strive to achieve a specific appearance and finish for the speaker grilles, without compromising on audio quality. Existing speaker grille designs may not effectively conceal openings, that are provided in the speaker grille for sound passage, which may impact an overall design aesthetic of the speaker grille.

### SUMMARY

In accordance with one embodiment of the present disclosure, a speaker grille for a vehicle is disclosed. The speaker grille comprises a base adapted to enclose a speaker of the vehicle. The base extends along a longitudinal direction. The base defines a first surface, a second surface opposite the first surface, a first side end, a second side end opposite the first side end, a top end, and a bottom end opposite the top end. The base comprises a first section defining a plurality of arrays of first through-holes. Each of the plurality of arrays of first through-holes extends along the longitudinal direction. Each first through-hole extends from the first surface to the second surface. The base further comprises a second section disposed adjacent to the first section. The second section defines a plurality of arrays of second through-holes. Each of the plurality of arrays of second through-holes extends along an oblique direction relative to the longitudinal direction and is angularly disposed relative to the plurality of arrays of first through-holes. Each second through-hole extends from the first surface to the second surface. The speaker grille further comprises a plurality of first ribs disposed in the first section and extending along the longitudinal direction from the first side end to the second side end. Each of the plurality of first ribs extends outwards from the first surface of the base along a transverse direction that is orthogonal to the longitudinal direction. Each of the plurality of arrays of first through-holes is disposed adjacent to a corresponding first rib from the plurality of first ribs. The speaker grille further comprises a plurality of second ribs disposed in the second section and extending along the oblique direction from the bottom end towards the top end. The plurality of second ribs is angularly disposed relative to the plurality of first ribs. Further, each of the plurality of second ribs extends outwards from the first surface of the base along the transverse direction. Each of the plurality of arrays of second through-holes is disposed adjacent to a corresponding second rib from the plurality of second ribs.

In accordance with another embodiment of the present disclosure, a door for a vehicle is disclosed. The door comprises a frame. The door further comprises a speaker grille coupled with the frame. The speaker grille comprises a base adapted to enclose a speaker of the vehicle. The base extends along a longitudinal direction. The base defines a first surface, a second surface opposite the first surface, a first side end, a second side end opposite the first side end, a top end, and a bottom end opposite the top end. The base comprises a first section defining a plurality of arrays of first through-holes. Each of the plurality of arrays of first through-holes extends along the longitudinal direction. Each first through-hole extends from the first surface to the second surface. The base further comprises a second section disposed adjacent to the first section. The second section defines a plurality of arrays of second through-holes. Each of the plurality of arrays of second through-holes extends along an oblique direction relative to the longitudinal direction and is angularly disposed relative to the plurality of arrays of first through-holes. Each second through-hole extends from the first surface to the second surface. The speaker grille further comprises a plurality of first ribs disposed in the first section and extending along the longitudinal direction from the first side end to the second side end. Each of the plurality of first ribs extends outwards from the first surface of the base along a transverse direction that is orthogonal to the longitudinal direction. Each of the plurality of arrays of first through-holes is disposed adjacent to a corresponding first rib from the plurality of first ribs. The speaker grille further comprises a plurality of second ribs disposed in the second section and extending along the oblique direction from the bottom end towards the top end. The plurality of second ribs is angularly disposed relative to the plurality of first ribs. Further, each of the plurality of second ribs extends outwards from the first surface of the base along the transverse direction. Each of the plurality of arrays of second through-holes is disposed adjacent to a corresponding second rib from the plurality of second ribs.

In accordance with yet a further embodiment of the present disclosure, a vehicle is disclosed. The vehicle comprises a vehicle frame. The vehicle further comprises at least one door coupled to the vehicle frame. The at least one door comprises a frame. The at least one door further comprises a speaker grille coupled with the frame. The speaker grille comprises a base adapted to enclose a speaker of the vehicle. The base extends along a longitudinal direction. Further, the base defines a first surface, a second surface opposite the first surface, a first side end, a second side end opposite the first side end, a top end, and a bottom end opposite the top end. Further, the base comprises a first section defining a plurality of arrays of first through-holes. Each of the plurality of arrays of first through-holes extends along the longitudinal direction. Each first through-hole extends from the first surface to the second surface. The base further comprises a second section disposed adjacent to the first section. The second section defines a plurality of arrays of second through-holes. Each of the plurality of arrays of second through-holes extends along an oblique direction relative to the longitudinal direction and is angularly disposed relative to the plurality of arrays of first through-holes. Each second through-hole extends from the first surface to the second surface. The speaker grille further comprises a plurality of first ribs disposed in the first section and extending along the longitudinal direction from the first side end to the second side end. Each of the plurality of first ribs extends outwards from the first surface of the base along a transverse direction that is orthogonal to the longitudinal direction. Each of the plurality of arrays of first through-holes is disposed adjacent to a corresponding first rib from the plurality of first ribs. Furthermore, the speaker grille comprises a plurality of second ribs disposed in the second section and extending along the oblique direction from the bottom end towards the top end. The plurality of second ribs is angularly disposed relative to the plurality of first ribs. Further, each of the plurality of second ribs extends outwards from the first surface of the base along the transverse direction. Each of the plurality of arrays of second through-holes is disposed adjacent to a corresponding second rib from the plurality of second ribs.

### BRIEF DESCRIPTION OF THE DRAWINGS

Certain embodiments of the present disclosure will be better understood from the following description taken in conjunction with the accompanying drawings in which:

FIG. 1 is a schematic side view of a vehicle, in accordance with an embodiment of the present disclosure;

FIG. 2 is a schematic view of a door of the vehicle of FIG. 1 installed with a speaker grille, in accordance with an embodiment of the present disclosure;

FIG. 3 is a detailed schematic view of the speaker grille of FIG. 2, in accordance with an embodiment of the present disclosure;

FIG. 4 is a magnified schematic view of a section X of the speaker grille, in accordance with an embodiment of the present disclosure;

FIG. 5 is a magnified schematic view of a section Y of the speaker grille, in accordance with an embodiment of the present disclosure; and

FIG. 6 is a sectional view of a portion of the speaker grille of FIG. 3, in accordance with an embodiment of the present disclosure.

### DETAILED DESCRIPTION OF EXEMPLARY EMBODIMENTS

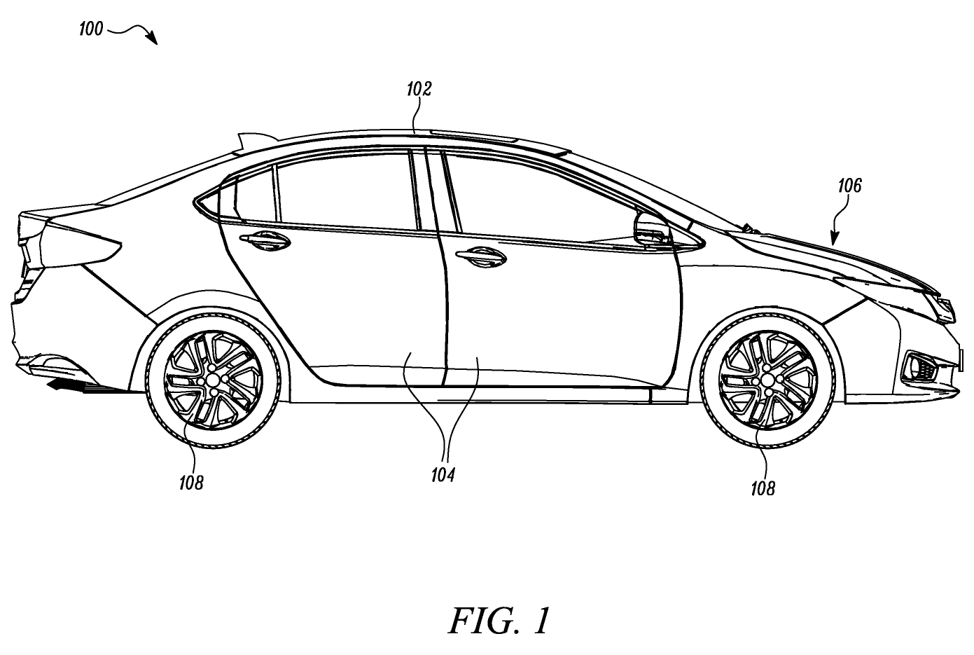

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-6, wherein like numbers indicate the same or corresponding elements throughout the views.

FIG. 1 illustrates a schematic side view of a vehicle 100, in accordance with an embodiment of the present disclosure. As shown, the vehicle 100 includes a vehicle frame 102. The vehicle 100 also includes at least one door 104 coupled to the vehicle frame 102. It should be noted that the vehicle 100 can include two doors or four doors, however, only two doors are shown in the view depicted in FIG. 1. The vehicle frame 102 defines a compartment 106 to accommodate a power source (not shown) of the vehicle 100. The vehicle 100 further includes a plurality of wheels 108 for supporting the vehicle frame 102 on a ground surface (not shown). The wheels 108 enable a movement of the vehicle 100 over the ground surface. Although the vehicle 100 is shown as a passenger car herein, it may be appreciated that the vehicle 100 may include any other type of vehicle, as per desired application attributes.

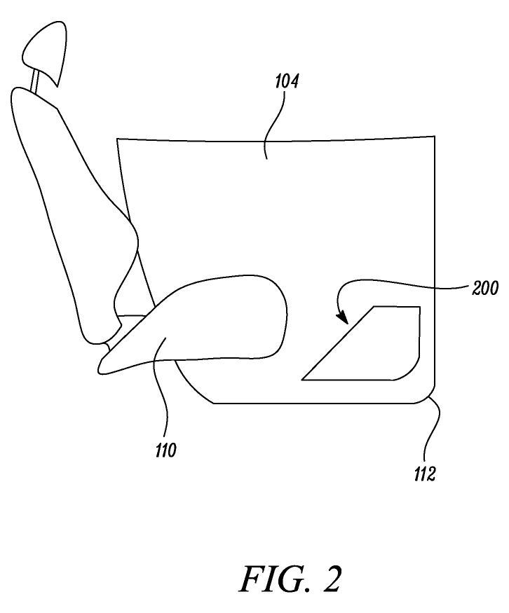

FIG. 2 illustrates a schematic view of a portion of the vehicle 100 of FIG. 1, in accordance with an embodiment of the present disclosure. The vehicle 100 defines a floor (not shown) on which multiple seats 110 (only one of which is shown in FIG. 2) is mounted. Further, the at least one door 104 includes a frame 112. The at least one door 104 further includes a speaker grille 200 coupled with the frame 112. The present disclosure relates to the speaker grille 200 for the vehicle 100. In the illustrated embodiment of FIG. 2, the speaker grille 200 is disposed proximal to a bottom side of the frame 112. It should be noted that a location of the speaker grille 200 on the frame 112 is exemplary, and the speaker grille 200 may be disposed at any other suitable location on the frame 112.

The at least one door 104 may be hereinafter interchangeably referred as “the door 104”. Although the speaker grille 200 is shown having a trapezoid shape, it may be appreciated that the speaker grille 200 may have any other shape, such as, but not limited to, square, rectangle, triangle, circle, etc.

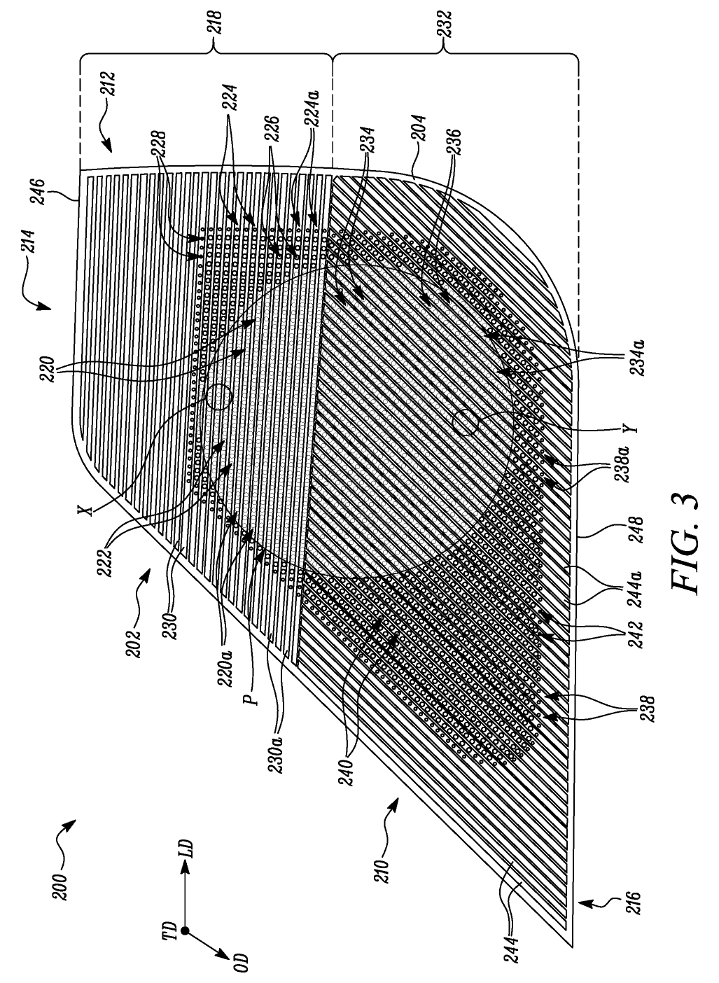

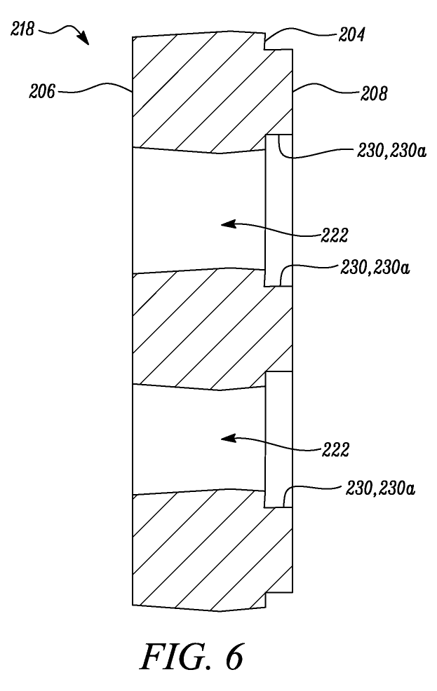

FIG. 3 illustrates a detailed schematic view of the speaker grille 200 of FIG. 2, in accordance with an embodiment of the present disclosure. As shown in FIG. 3, the speaker grille 200 for the vehicle 100 (shown in FIG. 1) includes a base 202 adapted to enclose a speaker (not shown) of the vehicle 100. The base 202 extends along a longitudinal direction LD. Further, the base 202 defines a first surface 204, a second surface 206 (shown in FIG. 6) opposite the first surface 204, a first side end 210, a second side end 212 opposite the first side end 210, a top end 214, and a bottom end 216 opposite the top end 214.

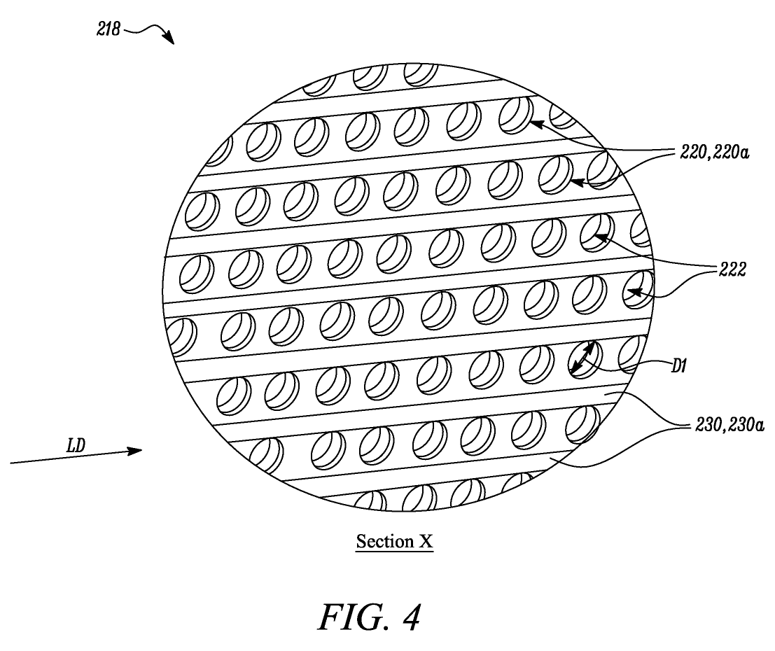

FIG. 4 illustrates a magnified schematic view of a section X (as shown in FIG. 3) of the speaker grille 200 shown in FIG. 3, in accordance with an embodiment of the present disclosure. As shown in FIGS. 3 and 4, the base 202 includes a first section 218 defining a plurality of arrays 220 of first through-holes 222. Each of the plurality of arrays 220 of first through-holes 222 extends along the longitudinal direction LD. The plurality of arrays 220 is parallel to each other. Each first through-hole 222 extends from the first surface 204 to the second surface 206. Further, each first through-hole 222 has a diameter D1.

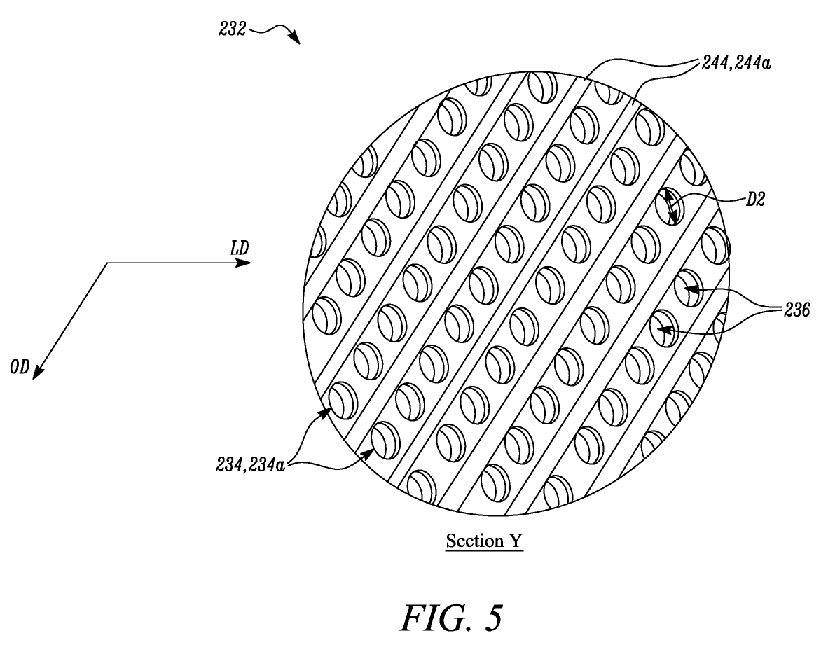

FIG. 5 illustrates a magnified schematic view of a section Y (as shown in FIG. 3) of the speaker grille 200 shown in FIG. 3, in accordance with an embodiment of the present disclosure. Referring to FIGS. 3 and 5, the base 202 further includes a second section 232 disposed adjacent to the first section 218. The second section 232 defines a plurality of arrays 234 of second through-holes 236. Each of the plurality of arrays 234 of second through-holes 236 extends along an oblique direction OD relative to the longitudinal direction LD. Further, each of the plurality of arrays 234 of second through-holes 236 is angularly disposed relative to the plurality of arrays 234 of first through-holes 222. The plurality of arrays 234 is parallel to each other. Each second through-hole 236 extends from the first surface 204 to the second surface 206. Further, each second through-hole 236 has a diameter D2.

Furthermore, in some embodiments, the diameter D1 (see FIG. 4) of each first through-hole 222 from the plurality of arrays 220 of first through-holes 222 is equal to the diameter D2 of each second through-hole 236 from the plurality of arrays 234 of second through-holes 236. In some embodiments, the plurality of arrays 220 of first through-holes 222 and the plurality of arrays 234 of second through-holes 236 are arranged to define a pattern P. In the illustrated embodiment of FIG. 3, the pattern P is circular in shape herein. However, the plurality of arrays 220 and the plurality of arrays 234 may be arranged to form any other pattern, as per desired applications.

As shown in FIG. 3, the speaker grille 200 further includes a plurality of first ribs 230 disposed in the first section 218. The plurality of first ribs 230 extends along the longitudinal direction LD from the first side end 210 to the second side end 212. The plurality of first ribs 230 is disposed parallel to each other. Each of the plurality of first ribs 230 extends outwards from the first surface 204 of the base 202 along a transverse direction TD that is orthogonal to the longitudinal direction LD. Each of the plurality of arrays 220 of first through-holes 222 is disposed adjacent to a corresponding first rib 230a from the plurality of first ribs 230.

In some embodiments, the first section 218 further defines a plurality of arrays 224 of first holes 226, 228. Each of the plurality of arrays 224 of first holes 226, 228 extends along the longitudinal direction LD and is disposed adjacent to the corresponding first rib 230a from the plurality of first ribs 230. The plurality of arrays 224 is parallel to each other. Each first hole 226, 228 from the plurality of arrays 224 of first holes 226, 228 extends partially from the first surface 204 towards the second surface 206. Accordingly, each first hole 226, 228 is a blind hole. Further, some of the arrays 224a from the plurality of arrays 224 are in alignment with a corresponding array 220a from the plurality of arrays 220. In some embodiments, each of the plurality of arrays 224 of first holes 226, 228 is in alignment with the corresponding array 220a of first through-holes 222 from the plurality of arrays 220 of first through-holes 222. The first holes 228 are disposed proximal to a periphery 246 of the first section 218. In the illustrated embodiment of FIG. 3, a diameter (not shown) of the first holes 228 is lesser than a diameter of the first holes 226.

The speaker grille 200 further includes a plurality of second ribs 244 disposed in the second section 232. The plurality of second ribs 244 extends along the oblique direction OD from the bottom end 216 towards the top end 214. The plurality of second ribs 244 is angularly disposed relative to the plurality of first ribs 230. The plurality of second ribs 244 is disposed parallel to each other. Further, each of the plurality of second ribs 244 extends outwards from the first surface 204 of the base 202 along the transverse direction TD. Each of the plurality of arrays 234 of second through-holes 236 is disposed adjacent to a corresponding second rib 244a from the plurality of second ribs 244.

In some embodiments, the second section 232 further defines a plurality of arrays 238 of second holes 240, 242. Each of the plurality of arrays 238 of second holes 240, 242 extends along the oblique direction OD and is disposed adjacent to the corresponding second rib 244a from the plurality of second ribs 244. The plurality of arrays 238 is parallel to each other. Each second hole 240, 242 from the plurality of arrays 238 of second holes 240, 242 extends partially from the first surface 204 towards the second surface 206. Accordingly, each second hole 240, 242 is a blind hole. Some of the arrays 238a from the plurality of arrays 238 are in alignment with a corresponding array 234a from the plurality of arrays 234. In some embodiments, each of the plurality of arrays 238 of second holes 240, 242 is in alignment with the corresponding array 234a of second through-holes 236 from the plurality of arrays 234 of second through-holes 236. The second holes 242 are disposed proximal to a periphery 248 of the second section 232. In the illustrated embodiment of FIG. 3, a diameter of the second holes 242 is lesser than a diameter of the second holes 240.

In some embodiments, the plurality of arrays 220 of first through-holes 222, the plurality of arrays 224 of first holes 226, 228, the plurality of arrays 234 of second through-holes 236, and the plurality of arrays 238 of second holes 240, 242 are arranged in a shape that corresponds to a shape of the base 202. Accordingly, the plurality of arrays 220, the plurality of arrays 224, the plurality of arrays 234, and the plurality of arrays 238 are arranged to form a substantially trapezoidal shape herein.

In the illustrated embodiment of FIG. 3, the plurality of first ribs 230 and the plurality of second ribs 244 are integral with the base 202. In other words, the speaker grille 200 is a single-piece component herein. Further, the speaker grille 200 may be manufactured using an injection molding process. However, the speaker grille 200 may be manufactured using any other process, without any limitations.

FIG. 6 illustrates a sectional view of a portion of the first section 218, in accordance with an embodiment of the present disclosure. As shown in FIG. 6, the speaker grille 200 defines an outermost surface 208. Although FIG. 6 only illustrates the first section 218, it may be appreciated that the second section 232 (see FIG. 3) may be also defined in a similar exemplary illustration. In some embodiments, the plurality of first ribs 230 and the plurality of second ribs 244 (see FIG. 3) together define the outermost surface 208. Referring to FIGS. 3 and 6, in some embodiments, the plurality of arrays 220 of first through-holes 222 and the plurality of arrays 234 of second through-holes 236 are sub-flush from the outermost surface 208. In other words, as the first surface 204 and the outermost surface 208 are disposed at an offset, a point of origin of each first through-hole 222 and each second through-hole 236 is offset from the outermost surface 208.

The first and second ribs 230, 244 may hide the first and second through-holes 222, 236 when an occupant seated on the seat 110 (see FIG. 2) of the vehicle 100 (see FIG. 1) looks at the speaker grille 200 from the seated position. Accordingly, the first and second through-holes 222, 236 may not be visible at non-direct viewing angles, which may improve aesthetics of the speaker grille 200. The speaker grille 200 described herein may have an improved speaker grille aesthetics, while achieving a desired audio performance.

The foregoing description of embodiments and examples has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the disclosure is, of course, not limited to the examples or embodiments set forth herein, but can be employed in any number of applications and equivalent devices by those of ordinary skill in the art. Rather it is hereby intended that the scope of the disclosure be defined by the claims appended hereto.

What is claimed is:

1. A speaker grille for a vehicle, the speaker grille comprising:
a base adapted to enclose a speaker of the vehicle, wherein the base extends along a longitudinal direction, wherein the base defines a first surface, a second surface opposite the first surface, a first side end, a second side end opposite the first side end, a top end, and a bottom end opposite the top end, and wherein the base includes:
a first section defining a plurality of arrays of first through-holes, wherein each of the plurality of arrays of first through-holes extends along the longitudinal direction, and wherein each first through-hole extends from the first surface to the second surface; and
a second section disposed adjacent to the first section, wherein the second section defines a plurality of arrays of second through-holes, wherein each of the plurality of arrays of second through-holes extends along an oblique direction relative to the longitudinal direction and is angularly disposed relative to the plurality of arrays of first through-holes, and wherein each second through-hole extends from the first surface to the second surface;
a plurality of first ribs disposed in the first section and extending along the longitudinal direction from the first side end to the second side end, wherein each of the plurality of first ribs extends outwards from the first surface of the base along a transverse direction that is orthogonal to the longitudinal direction, and wherein each of the plurality of arrays of first through-holes is disposed adjacent to a corresponding first rib from the plurality of first ribs; and
a plurality of second ribs disposed in the second section and extending along the oblique direction from the bottom end towards the top end, wherein the plurality of second ribs is angularly disposed relative to the plurality of first ribs, wherein each of the plurality of second ribs extends outwards from the first surface of the base along the transverse direction, and wherein each of the plurality of arrays of second through-holes is disposed adjacent to a corresponding second rib from the plurality of second ribs.

2. The speaker grille of claim 1, wherein the first section further defines a plurality of arrays of first holes, wherein each of the plurality of arrays of first holes extends along the longitudinal direction and is disposed adjacent to a corresponding first rib from the plurality of first ribs, wherein each first hole from the plurality of arrays of first holes extends partially from the first surface towards the second surface, and wherein each of the plurality of arrays of first holes is in alignment with a corresponding array of first through-holes from the plurality of arrays of first through-holes.

3. The speaker grille of claim 2, wherein the second section further defines a plurality of arrays of second holes, wherein each of the plurality of arrays of second holes extends along the oblique direction and is disposed adjacent to a corresponding second rib from the plurality of second ribs, wherein each second hole from the plurality of arrays of second holes extends partially from the first surface towards the second surface, and wherein each of the plurality of arrays of second holes is in alignment with a corresponding array of second through-holes from the plurality of arrays of second through-holes.

4. The speaker grille of claim 3, wherein the plurality of arrays of first through-holes, the plurality of arrays of first holes, the plurality of arrays of second through-holes, and the plurality of arrays of second holes are arranged in a shape that corresponds to a shape of the base.

5. The speaker grille of claim 1, wherein a diameter of each first through-hole from the plurality of arrays of first through-holes is equal to a diameter of each second through-hole from the plurality of arrays of second through-holes.

6. The speaker grille of claim 1, wherein the plurality of first ribs and the plurality of second ribs are integral with the base.

7. The speaker grille of claim 1, wherein the plurality of arrays of first through-holes and the plurality of arrays of second through-holes are arranged to define a pattern, and wherein the pattern is circular in shape.

8. The speaker grille of claim 1, wherein the plurality of first ribs and the plurality of second ribs together define an outermost surface, and wherein the plurality of arrays of first through-holes and the plurality of arrays of second through-holes are sub-flush from the outermost surface.

9. A door for a vehicle, the door comprising:
a frame; and
a speaker grille coupled with the frame, the speaker grille comprising:
a base adapted to enclose a speaker of the vehicle, wherein the base extends along a longitudinal direction, wherein the base defines a first surface, a second surface opposite the first surface, a first side end, a second side end opposite the first side end, a top end, and a bottom end opposite the top end, and wherein the base includes:
a first section defining a plurality of arrays of first through-holes, wherein each of the plurality of arrays of first through-holes extends along the longitudinal direction, and wherein each first through-hole extends from the first surface to the second surface; and
a second section disposed adjacent to the first section, wherein the second section defines a plurality of arrays of second through-holes, wherein each of the plurality of arrays of second through-holes extends along an oblique direction relative to the longitudinal direction and is angularly disposed relative to the plurality of arrays of first through-holes, and wherein each second through-hole extends from the first surface to the second surface;
a plurality of first ribs disposed in the first section and extending along the longitudinal direction from the first side end to the second side end, wherein each of the plurality of first ribs extends outwards from the first surface of the base along a transverse direction that is orthogonal to the longitudinal direction, and wherein each of the plurality of arrays of first through-holes is disposed adjacent to a corresponding first rib from the plurality of first ribs; and
a plurality of second ribs disposed in the second section and extending along the oblique direction from the bottom end towards the top end, wherein the plurality of second ribs is angularly disposed relative to the plurality of first ribs, wherein each of the plurality of second ribs extends outwards from the first surface of the base along the transverse direction, and wherein each of the plurality of arrays of second through-holes is disposed adjacent to a corresponding second rib from the plurality of second ribs.

10. The door of claim 9, wherein the first section further defines a plurality of arrays of first holes, wherein each of the plurality of arrays of first holes extends along the longitudinal direction and is disposed adjacent to a corresponding first rib from the plurality of first ribs, wherein each first hole from the plurality of arrays of first holes extends partially from the first surface towards the second surface, and wherein each of the plurality of arrays of first holes is in alignment with a corresponding array of first through-holes from the plurality of arrays of first through-holes.

11. The door of claim 10, wherein the second section further defines a plurality of arrays of second holes, wherein each of the plurality of arrays of second holes extends along the oblique direction and is disposed adjacent to a corresponding second rib from the plurality of second ribs, wherein each second hole from the plurality of arrays of second holes extends partially from the first surface towards the second surface, and wherein each of the plurality of arrays of second holes is in alignment with a corresponding array of second through-holes from the plurality of arrays of second through-holes.

12. The door of claim 11, wherein the plurality of arrays of first through-holes, the plurality of arrays of first holes, the plurality of arrays of second through-holes, and the plurality of arrays of second holes are arranged in a shape that corresponds to a shape of the base.

13. The door of claim 9, wherein a diameter of each first through-hole from the plurality of arrays of first through-holes is equal to a diameter of each second through-hole from the plurality of arrays of second through-holes.

14. The door of claim 9, wherein the plurality of arrays of first through-holes and the plurality of arrays of second through-holes are arranged to define a pattern, and wherein the pattern is circular in shape.

15. The door of claim 9, wherein the plurality of first ribs and the plurality of second ribs together define an outermost surface, and wherein the plurality of arrays of first through-holes and the plurality of arrays of second through-holes are sub-flush from the outermost surface.

16. A vehicle comprising:
a vehicle frame; and
at least one door coupled to the vehicle frame, the at least one door comprising:
a frame; and
a speaker grille coupled with the frame, the speaker grille comprising:
a base adapted to enclose a speaker of the vehicle, wherein the base extends along a longitudinal direction, wherein the base defines a first surface, a second surface opposite the first surface, a first side end, a second side end opposite the first side end, a top end, and a bottom end opposite the top end, and wherein the base includes:
a first section defining a plurality of arrays of first through-holes, wherein each of the plurality of arrays of first through-holes extends along the longitudinal direction, and wherein each first through-hole extends from the first surface to the second surface; and
a second section disposed adjacent to the first section, wherein the second section defines a plurality of arrays of second through-holes, wherein each of the plurality of arrays of second through-holes extends along an oblique direction relative to the longitudinal direction and is angularly disposed relative to the plurality of arrays of first through-holes, and wherein each second through-hole extends from the first surface to the second surface;
a plurality of first ribs disposed in the first section and extending along the longitudinal direction from the first side end to the second side end, wherein each of the plurality of first ribs extends outwards from the first surface of the base along a transverse direction that is orthogonal to the longitudinal direction, and wherein each of the plurality of arrays of first through-holes is disposed adjacent to a corresponding first rib from the plurality of first ribs; and
a plurality of second ribs disposed in the second section and extending along the oblique direction from the bottom end towards the top end, wherein the plurality of second ribs is angularly disposed relative to the plurality of first ribs, wherein each of the plurality of second ribs extends outwards from the first surface of the base along the transverse direction, and wherein each of the plurality of arrays of second through-holes is disposed adjacent to a corresponding second rib from the plurality of second ribs.

17. The vehicle of claim 16, wherein the first section further defines a plurality of arrays of first holes, wherein each of the plurality of arrays of first holes extends along the longitudinal direction and is disposed adjacent to a corresponding first rib from the plurality of first ribs, wherein each first hole from the plurality of arrays of first holes extends partially from the first surface towards the second surface, and wherein each of the plurality of arrays of first holes is in alignment with a corresponding array of first through-holes from the plurality of arrays of first through-holes.

18. The vehicle of claim 17, wherein the second section further defines a plurality of arrays of second holes, wherein each of the plurality of arrays of second holes extends along the oblique direction and is disposed adjacent to a corresponding second rib from the plurality of second ribs, wherein each second hole from the plurality of arrays of second holes extends partially from the first surface towards the second surface, and wherein each of the plurality of arrays of second holes is in alignment with a corresponding array of second through-holes from the plurality of arrays of second through-holes.

19. The vehicle of claim 18, wherein the plurality of arrays of first through-holes, the plurality of arrays of first holes, the plurality of arrays of second through-holes, and the plurality of arrays of second holes are arranged in a shape that corresponds to a shape of the base.

20. The vehicle of claim 16, wherein a diameter of each first through-hole from the plurality of arrays of first through-holes is equal to a diameter of each second through-hole from the plurality of arrays of second through-holes.
